(19) United States
(12) Patent Application Publication
(10) Pub. No.: US 2021/0157446 A1
(43) Pub. Date: May 27, 2021

(54) ELECTRONIC DEVICE

(71) Applicant: SHARP KABUSHIKI KAISHA, Sakai City (JP)

(72) Inventor: YASUTOMO NAKAHARA, Sakai City (JP)

(21) Appl. No.: 16/950,651

(22) Filed: Nov. 17, 2020

(30) Foreign Application Priority Data
Nov. 27, 2019 (JP) 2019-214448

(51) Int. Cl. G06F 3/044; G06F 1/3218

(52) U.S. Cl. CPC G06F 3/0443; G06F 2203/04106; G06F 1/3218; G06F 3/0446

(57) ABSTRACT

An electronic device includes a touch panel having a power reception unit that receives power from a power transmission device in a contactless manner and a touch sensor, a driving frequency change unit that changes, in a case where it is detected that the power reception unit is being charged in a contactless manner, a driving frequency of the touch panel from a first frequency to a second frequency, and a threshold change unit that changes, in a case where it is detected that the power reception unit is being charged in a contactless manner, a minimum detection value of the touch panel from a first threshold to a second threshold, which is smaller than the first threshold.

### BACKGROUND

### 1. Field

An aspect of the present disclosure relates to an electronic device having a touch panel.

### 2. Description of the Related Art

In recent years, contactless chargers have been becoming widely used, which can charge electronic devices in a contactless (wireless) manner. In a case where an electronic device is being charged in a contactless manner using such a contactless charger, noise is generated when the frequency of a wireless signal generated by contactless charging overlaps a driving frequency for driving the electronic device, and the electronic device may malfunction. In order to prevent such a malfunction, there have been proposed technologies that make it possible to change the driving frequency of an electronic device in accordance with ambient environments.

For example, in Japanese Unexamined Patent Application Publication No. 2013-114326, a touch panel device is described that prevents, in a case where the fluctuations in a capacitance measurement result increase in the touch panel device, the touch panel from performing an erroneous determination by changing the driving frequency of a touch panel module.

However, in a case where the driving frequency of an electronic device that is being charged in a contactless manner is lowered by applying, to the electronic device, a technology described in Japanese Unexamined Patent Application Publication No. 2013-114326, the detection sensitivity of the touch panel may decrease during contactless charging, and thus the operability of the touch panel may decrease.

It is desirable to realize an electronic device that sufficiently prevents the touch panel from malfunctioning at the time of contactless charging and that ensures the operability of the touch panel.

### SUMMARY

According to an aspect of the present disclosure, there is provided an electronic device including a touch panel having a power reception unit that receives power from a power transmission device in a contactless manner and a touch sensor, a driving frequency change unit that changes, in a case where it is detected that the power reception unit is being charged in a contactless manner, a driving frequency of the touch panel from a first frequency to a second frequency, and a threshold change unit that changes, in a case where it is detected that the power reception unit is being charged in a contactless manner, a minimum detection value of the touch panel from a first threshold to a second threshold, which is smaller than the first threshold.

### BRIEF DESCRIPTION OF THE DRAWINGS

FIG. 1 is a block diagram of an electronic device according to a first embodiment of the present disclosure;

FIG. 2 is a flow chart illustrating the procedure of control of the electronic device according to the first embodiment at the time of contactless charging;

FIG. 3 is a flow chart illustrating the procedure of detection-region size determination processing according to the first embodiment; and

FIG. 4 illustrates a specific example of a detection-region size according to he first embodiment.

### DESCRIPTION OF THE EMBODIMENTS

### First Embodiment

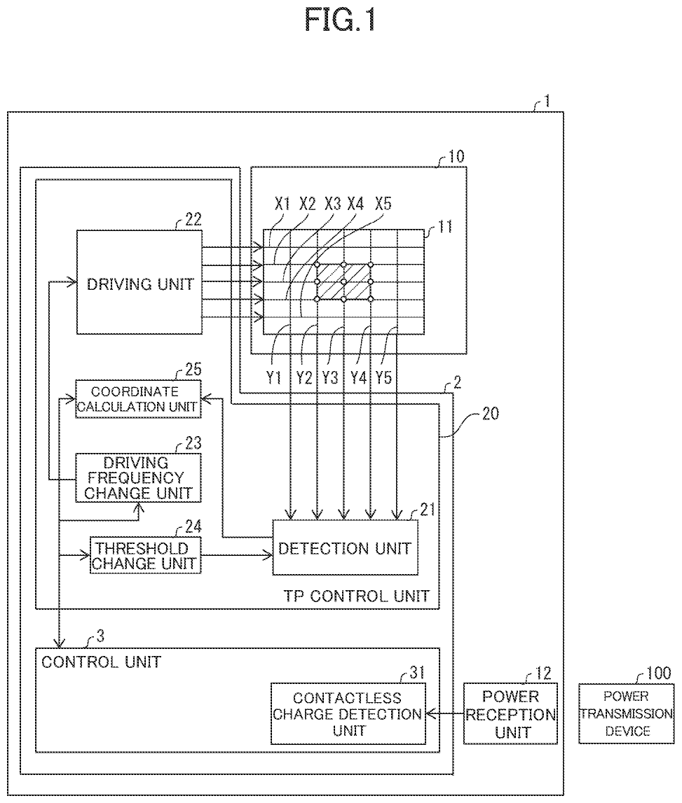

In the following, a first embodiment of the present disclosure will be described with reference to FIGS. 1 to 4. FIG. 1 is a block diagram of an electronic device 1 according to the first embodiment. As illustrated in FIG. 1, the electronic device 1 includes a touch panel 10, a touch panel (TP) control device 2, and a power reception unit 12. The electronic device 1 is used in, for example, mobile phones, smartphones, and tablet computers.

The touch panel 10 has a touch sensor 11. The touch sensor 11 is configured such that a plurality of driving electrodes X1 to X5, which are arranged so as to be parallel to each other, pass over or under a plurality of detection electrodes Y1 to Y5, which are arranged so as to be parallel to each other and perpendicular to the plurality of driving electrodes X1 to X5. The touch sensor 11 detects contact or proximity of a user's finger, a pointing object, and the like to the touch panel 10 on the basis of changes in the capacitances between the electrodes caused by contact or proximity of the user's finger, the pointing object, and the like to the touch panel 10.

The TP control device 2 has a TP control unit 20 and a control unit 3. The TP control device 2 is connected to the touch panel 10, and calculates positions on the touch panel 10 where a user's finger, a pointing object, and the like have touched.

The TP control unit 20 includes a detection unit 21, a driving unit 22, a driving frequency change unit 23, a threshold change unit 24, and a coordinate calculation unit 25. The detection unit 21 is connected to the plurality of detection electrodes Y1 to Y5. The detection unit 21 detects a detection signal from the plurality of detection electrodes Y1 to Y5. The detection unit 21 detects contact or proximity of a user's finger, a pointing object, and the like to the touch panel 10 by comparing a detection signal output from the touch sensor 11 with a reference threshold.

The driving unit 22 is connected to the plurality of driving electrodes X1 to X5. The driving unit 22 applies a driving signal having a driving frequency, which is described below, to these driving electrodes X1 to X5. Note that FIG. 1 illustrates a case where the five driving electrodes X1 to X5 are horizontally arranged, and the five detection electrodes Y1 to Y5 are vertically arranged. This is an example, and the number and arrangement of the driving electrodes X1 to X5 and those of the detection electrodes Y1 to Y5 may be set as appropriate in accordance with the size and position detection accuracy of the touch panel 10. In the following, for brevity, the case will be described where the five driving electrodes X1 to X5 are arranged so as to be parallel to each other, and the five detection electrodes Y1 to Y5 are arranged so as to be parallel to each other.

In a case where it is detected that the power reception unit 12 is being charged in a contactless manner, the driving frequency change unit 23 changes the driving frequency of the touch panel 10 through the driving unit 22. In a case where it is detected that the power reception unit 12 is being charged in a contactless manner, the threshold change unit 24 changes the reference threshold (a minimum detection value).

In normal times, the coordinate calculation unit 25 calculates coordinates of a touch position on the touch panel 10 on the basis of the detection signal detected by the detection unit 21 and outputs the calculated coordinate data to the control unit 3. In contrast, during contactless charging, the coordinate calculation unit 25 outputs the calculated coordinates to the control unit 3 on the condition that the size of a region where the touch panel 10 has detected touching is greater than or equal to a predetermined size. That is, the coordinate calculation unit 25 calculates the size of the region where the touch panel 10 has detected touching, and in a case where the calculated size of the region is less than the predetermined size, the coordinate calculation unit 25 does not output the coordinate data of the touch position to the control unit 3 but cancels the coordinate data.

The control unit 3 is, for example, a central processing unit (CPU). The control unit 3 is connected to, for example, the driving frequency change unit 23, the threshold change unit 24, and the coordinate calculation unit 25 of the TP control unit 20, and controls various units of the electronic device 1 in a centralized manner.

In addition, the control unit 3 has a contactless charge detection unit 31. The contactless charge detection unit 31 determines whether the electronic device 1 is being charged in a contactless manner, on the basis of reception of a being-charged signal from the power reception unit 12 when the power reception unit 12 is being charged in a contactless manner. In a case where it is determined by the contactless charge detection unit 31 that the electronic device 1 is being charged in a contactless manner, the control unit 3 outputs a control signal to the driving frequency change unit 23 and the threshold change unit 24. The driving frequency change unit 23 changes the driving frequency of the touch panel 10 on the basis of reception of the control signal from the control unit 3. In addition, the threshold change unit 24 changes the reference threshold (minimum detection value) on the basis of reception of the control signal from the control unit 3.

The power reception unit 12 receives power from a power transmission device 100 in a contactless manner, for example, by electromagnetic induction. In a case where the power reception unit 12 is being charged by the power transmission device 100 in a contactless manner, the power reception unit 12 outputs a being-charged signal to the contactless charge detection unit 31. As the power transmission device 100, for example, a charger supporting the Qi standard can be used. Note that in order to perform contactless charging, the power reception unit 12 of the electronic device 1 is arranged at a predetermined position facing the power transmission device 100 and contactless charging is performed.

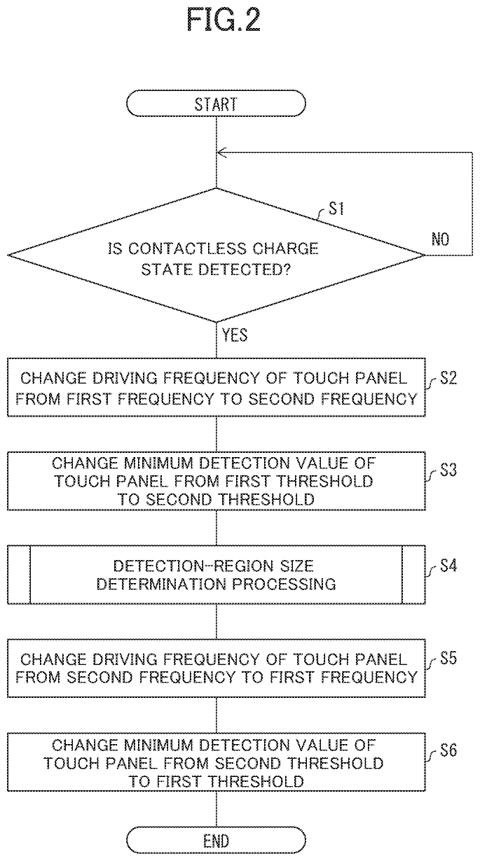

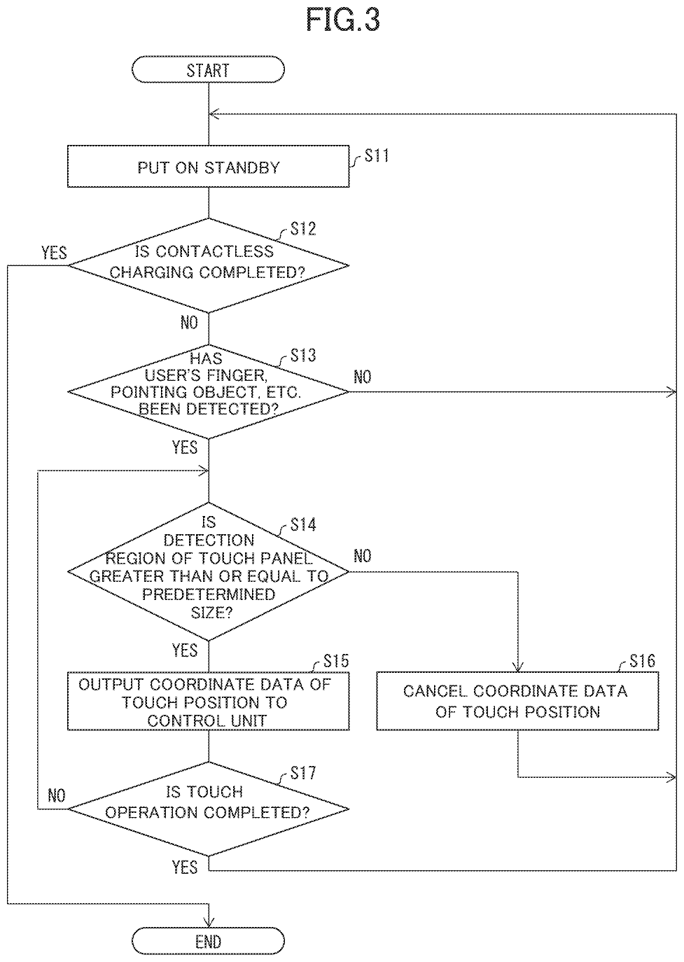

Next, a control operation of the electronic device 1 according to the first embodiment will be described with reference to FIGS. 2 and 3. FIG. 2 is a flow chart illustrating the procedure of control of the electronic device 1 according to the first embodiment at the time of contactless charging. FIG. 3 is a flow chart illustrating the procedure of detection-region size determination processing according to the first embodiment.

As illustrated in FIG. 2, first, the control unit 3 determines whether a contactless charge state is detected (S1). Specifically, the contactless charge detection unit 31 of the control unit 3 detects the contactless charge state on the basis of reception of a being-charged signal from the power reception unit 12.

In a case where the contactless charge state is not detected (NO in S1), the process returns to S1. In contrast, in a case where the contactless charge detection unit 31 detects the contactless charge state (YES in S1), the driving frequency change unit 23 of the TP control unit 20 changes the driving frequency of the touch panel 10 from a first frequency for normal times to a second frequency for when contactless charging is performed (S2).

In this case, the first frequency is, for example, about 130 to 230 kHz, and the second frequency is lower than the first frequency and is about 75 to 100 kHz. These frequencies are set by assuming that the driving frequency of the touch panel 10 is set to be lower than 110 to 205 kHz, which are driving frequencies for the Qi standard, during contactless charging. Consequently, the frequency of a wireless signal generated by power supply from the power transmission device 100 to the power reception unit 12 does not overlap the driving frequency of the touch panel 10, and it is possible to prevent noise from being generated by frequency overlapping.

Next, the threshold change unit 24 of the TP control unit 20 changes the minimum detection value of the touch panel 10 from a first threshold to a second threshold, which is smaller than the first threshold (S3). This is performed by considering that a detection signal output by the detection unit 21 on the basis of contact of a user's finger, a pointing object, and the like decreases during contactless charging.

Next, the detection-region size determination processing illustrated in FIG. 3 is performed (S4). FIG. 3 is a flow chart illustrating the procedure of the detection-region size determination processing according to the first embodiment. As illustrated in FIG. 3, the touch panel 10 is put on standby in the detection-region size determination processing (S11). In this case, “on standby” means a standby state in which, for example, the electronic device 1 is switched on and the display screen of the touch panel 10 is on.

Next, the control unit 3 determines whether contactless charging is completed, on the basis of a detection result from the contactless charge detection unit 31 (112). In a case where contactless charging is completed (YES in S12), the control unit 3 ends the detection-region size determination processing, and the process proceeds to S5 in FIG. 2. In contrast, in a case where contactless charging is not completed (NO in S12), the control unit 3 determines whether a user's finger, a pointing object, or the like has been detected (S13).

In a case where the detection. signal output from the touch sensor 11 is greater than or equal to the minimum detection value, that is, the second threshold, the detection unit 21 detects contact of a user's finger, a pointing object, or the like to the touch panel 10. In a case where the detection unit 21 has not detected contact of a user's finger, a pointing object, or the like (NO in S13), the process returns to S11. In contrast, in a case where the detection unit 21 has detected contact of a user's finger, a pointing object, or the like (YES in S13), the coordinate calculation unit 25 determines whether the detection region of the touch panel 10 is greater than or equal to the predetermined size (S14).

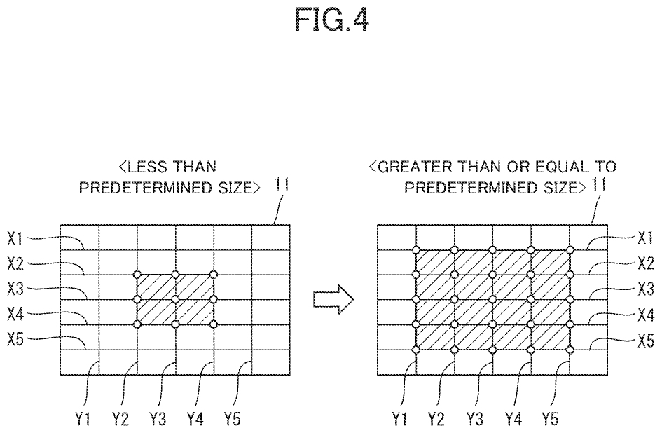

FIG. 4 illustrates a specific example of a detection-region size according to the first embodiment. As illustrated in the right portion of FIG. 4, in a case where the size of the region where the touch and 10 has detected. touching is greater than or equal to the predetermined size (YES in S14), the coordinate calculation unit 25 outputs calculated coordinate data to the control unit 3 (S15), and the process proceeds to S17.

In this case, the predetermined size as represented by for example the number of intersection points at which the detection unit 21 has detected touching among the intersection points of the driving electrodes X1 to X5 and the detection electrodes Y1 to Y5. That is, the coordinate calculation unit 25 counts the number of intersection points at which the detection unit 21 has detected touching. In a case where the number of intersection points obtained by counting is greater than or equal to a predetermined value (for example, 16), the coordinate calculation unit 25 outputs the calculated coordinate data to the control unit 3. The example in the right portion of FIG. 4 illustrates a state where the number of intersection points at which touching has been detected is 5×5=25, which is greater than or equal to the predetermined value.

In contrast, as illustrated in the left portion of FIG. 4, in a case where the size of the region where the touch panel 10 has detected touching is less than the predetermined size (NO in S14), the coordinate calculation unit 25 dose not output, to the control unit 3, but cancels the coordinate data of the touch position (S16), and the process returns to S11. The example in the left portion of FIG. 4 illustrates a state where the number of intersection points at which touching has been detected is 3×3=9, which is less than the predetermined value (for example, 16). In this manner, in the first embodiment, the coordinate calculation unit 25 outputs the calculated coordinate data on the condition that the number of intersection points at which touching has been detected by the touch sensor 11 is greater than or equal to the predetermined value, and thus it is possible to distinguish contact of a user's finger, a pointing object, and the like from contact of other objects with high accuracy.

Next, in S17, in is determined whether the touch operation is completed. In a case where the duration in which the detection signal is not output from the detection unit 21 is less than a predetermined time period, the control unit 3 determines that the touch operation is not completed (NO in S17), and the process returns to S14. In contrast, in a case where the detection signal from the detection unit 21 is not output continuously for the predetermined time period or more, the control unit 3 determines that the touch operation is completed (YES in S17), and the process returns to S11. In this manner, processing in S11 to S17 is repeatedly executed until contactless charging is completed. When contactless charging is completed, the detection-region size determination processing is ended, and the process proceeds to S5 in FIG. 2.

In S5 illustrated in FIG. 2, the driving frequency of the touch panel 10 is changed from the second frequency to the first frequency. The minimum detection value of the touch panel 10 is changed from the second threshold to the first threshold (S6). In this manner, the control operation for the electronic device 1 at the time of contactless charging in the first embodiment ends.

With the electronic device 1 in the first embodiment described above, in a case where it is detected that the power reception unit 12 is being charged in a contactless manner (YES in S1), the driving frequency change unit 23 changes the driving frequency of the touch panel 10 from the first frequency to the second frequency (S2) and the driving frequency can be made lower than the frequency of a wireless signal generated by contactless charging from the power transmission device 100 to the power reception unit 12. Consequently, the radio frequency output from the power transmission device 100 does not overlap the driving frequency of the touch panel 10, and it is possible to prevent noise from being generated by frequency overlapping, thereby making it possible to sufficiently prevent the touch panel 10 from malfunctioning.

Furthermore, the threshold change unit 24 changes the minimum detection value of the touch panel 10 from the first threshold to the second threshold (S3), thereby making it possible to increase the detection sensitivity of the touch panel 10, the second threshold being smaller than the first threshold. Consequently, the case can be prevented where lowering the driving frequency of the touch panel 10 reduces the detection sensitivity of the touch panel 10 and thus the operability of the touch panel 10 decreases. In this manner, the electronic device 1 can be realized that sufficiently prevents the touch panel 10 from malfunctioning at the time of contactless charging and that ensures the operability of the touch panel 10.

In addition, in a case where the size of the region where the touch panel 10 has detected touching is greater than or equal to the predetermined size (YES in S14), the coordinate calculation unit 25 outputs the coordinate data of the touch position to the control unit 3 (S15). In a case where the size of the region where the touch panel 10 has detected touching is less than the predetermined size (NO in S14), the coordinate calculation unit 25 cancels the coordinate data of the touch position (S16). Consequently, even when the minimum detection value of the touch panel 10 is reduced from the first threshold to the second threshold to increase the detection sensitivity of the touch panel 10, the touch panel 10 can be made less likely to malfunction because of ambient noise or the like.

### Modification

In the first embodiment, in S14 of FIG. 3, the coordinate data calculated by the coordinate calculation unit 25 is output to the control unit 3 on the condition that, as the predetermined size, the number of intersection points at which touching has been detected is greater than or equal to the predetermined value among the intersection points of the driving electrodes X1 to X5 and the detection electrodes Y1 to Y5; however, the condition is not limited to this.

For example, the coordinate data calculated by the coordinate calculation unit 25 may be output to the control unit 3 on the condition that the area of the region of the touch panel 10 where touching has been detected is greater than or equal to a predetermined area. Alternatively, the condition may be that the number of electrodes at which touching has been detected is greater than or equal to a predetermined value among the driving electrodes X1 to X5 and the detection electrodes Y1 to Y5.

### Second Embodiment

Each control block of the TP control device 2 in the electronic device 1 (especially, the driving frequency change unit 23, the threshold change unit 24, the coordinate calculation unit 25, and the contactless charge detection unit 31) may be realized by a logic circuit (a hardware device) formed on, for example, an integrated circuit (an IC chip) or may also be realized by a piece of software.

In the latter case, the TP control device 2 includes a computer that executes commands from a program that is a piece of software realizing individual functions. This computer includes, for example, at least one processor (a control device) and at least one computer readable recording medium storing the program described above. In the computer, an object of the present disclosure is achieved by the processor reading the program from the recording medium and executing the program. As the processor, for example, a central processing unit (CPU) can be used. As the recording medium, for example, a “non-temporary tangible medium” can be used such as a read-only memory (ROM), a tape, a disk, a card, a semiconductor memory, or a programmable logic circuit. In addition, the computer may further include a random access memory (RAM) in which to expand the program. In addition, the program, may be supplied to the computer via an arbitrary transmission medium (for example, a communication network or broadcast waves) capable of transmitting the program. Note that an embodiment of the present disclosure can be realized in a form in which the program is realized through electronic transmission and a data signal is embedded in a carrier wave.

### Summary of Embodiments

An electronic device according to a first aspect of the present disclosure includes a touch panel having a power reception unit that receives power from a power transmission device in a contactless manner and a touch sensor, a driving frequency change unit that changes, in a case where it is detected that the power reception unit is being charged in a contactless manner, a driving frequency of the touch panel from a first frequency to a second frequency, and a threshold change unit that changes, in a case where it is detected that the power reception unit is being charged in a contactless manner, a minimum detection value of the touch panel from a first threshold to a second threshold, which is smaller than the first threshold.

With the above-described configuration, in a case where it is detected that the power reception unit is being charged in a contactless manner, the driving frequency change unit changes the driving frequency of the touch panel from the first frequency to the second frequency, and also the threshold change unit changes the minimum detection value of the touch panel from the first threshold to the second threshold, which is smaller than the first threshold. Consequently, the touch panel can be sufficiently prevented from malfunctioning at the time of contactless charging lowering, during contactless charging, the driving frequency of the touch panel so as to be lower than the frequency of a wireless signal generated by contactless charging. Furthermore, the detection sensitivity of the touch panel can be increased by lowering the minimum detection value of the touch panel from the first threshold to the second threshold. Consequently, the case can be prevented where lowering the driving frequency of the touch panel reduces the detection sensitivity of the touch panel and thus the operability of the touch panel decreases. In this manner, the electronic device can be realized that sufficiently prevents the touch panel from malfunctioning at the time of contactless charging and that ensures the operability of the touch panel.

In a touch panel control device according to a second aspect of the present disclosure, the second frequency may be lower than the first frequency in the first aspect and may be lower than the frequency of a wireless signal generated by power supply from the power transmission device.

With the above-described configuration, in a case where it is detected that the power reception unit is being charged in a contactless manner, the driving frequency change unit changes the driving frequency of the touch panel to the second frequency, which is lower than the first frequency and the frequency of the wireless signal generated by power supply from the power transmission device. Consequently, the frequency of the wireless signal generated by power supply from the power transmission device does not overlap the driving frequency of the touch panel, and thus it is possible to prevent noise from being generated by frequency overlapping.

An electronic device according to a third aspect of the present disclosure may further include, in the first or second aspect, a coordinate calculation unit that calculates coordinates of a touch position on the touch panel. In a case where it is detected that the power reception unit is being charged in a contactless manner, the coordinate calculation unit may output the calculated coordinates on the condition that the size of a region where the touch panel has detected touching is greater than or equal to a predetermined size.

With the above-described configuration, during contactless charging, in a case where the size of the region where the touch panel has detected touching is less than the predetermined size, it is possible not to output the coordinates calculated by the coordinate calculation unit. Consequently, even when the minimum detection value of the touch panel is reduced from the first threshold to the second threshold to increase the detection sensitivity of the touch panel, the touch panel can be made less likely to malfunction because of noise or the like.

In an electronic device according to a fourth aspect of the present disclosure, the touch sensor in the third aspect may have a plurality of driving electrodes that are arranged so as to be parallel to each other and a plurality of detection electrodes that are arranged so as to be parallel to each other and perpendicular to the plurality of driving electrodes. In a case where it is detected that the power reception unit is being charged in a contactless manner, the coordinate calculation unit may output calculated coordinate data on the condition that the number of intersection points at which the touch sensor has detected touching among intersection points of the driving electrodes and the detection electrodes is greater than or equal to a predetermined value.

With the above-described configuration, the coordinate calculation unit outputs the calculated coordinate data on the condition that the number of intersection points at which the touch sensor has detected touching is greater than or equal to the predetermined value. Thus, it is possible to distinguish contact of a user's finger, a pointing object, and the like from contact of other objects with high accuracy, thereby making it possible to sufficiently prevent the touch panel from malfunctioning.

The present disclosure is not limited to the above-described embodiments. Various changes can be made within the scope of the claims, and embodiments obtained by combining, as appropriate, technical units disclosed in respective different embodiments are also included in the technical scope of the present disclosure. Furthermore, new technical characteristics can be formed by combining technical units disclosed in respective different embodiments.

The present disclosure contains subject matter related to that disclosed in Japanese Priority Patent Application JP 2019-214448 filed in the Japan Patent Office on Nov. 27, 2019, the entire contents of which are hereby incorporated by reference.

While there have been described what are at present considered to be certain embodiments of the invention, it will be understood that various modifications may be made thereto, and it is intended that the appended claims cover all such modifications as fail within the true spirit and scope of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic device comprising:
a touch panel having a power reception unit that receives power from a power transmission device in a contactless manner and a touch sensor;
a driving frequency change unit that changes, in a case where it is detected that the power reception unit is being charged in a contactless manner, a driving frequency of the touch panel from a first frequency to a second frequency; and
a threshold change unit that changes, in a case where it is detected that the power reception unit is being charged in a contactless manner, a minimum detection value of the touch panel from a first threshold to a second threshold, which is smaller than the first threshold.

2. The electronic device according to claim 1, wherein the second frequency is lower than the first frequency and is lower than a frequency of a wireless signal generated by power supply from the power transmission device.

3. The electronic device according to claim 1, further comprising:
a coordinate calculation unit that calculates coordinates of a touch position on the touch panel,
wherein in a case where it is detected that the power reception unit is being charged in a contactless manner, the coordinate calculation unit outputs calculated coordinate data on a condition that a size of a region where the touch panel has detected touching is greater than or equal to a predetermined size.

4. The electronic device according to claim 3, wherein
the touch sensor has a plurality of driving electrodes that are arranged so as to be parallel to each other and a plurality of detection electrodes that are arranged so as to he parallel to each other and perpendicular to the plurality of driving electrodes, and
in a case where it is detected that the power reception unit is being charged in a contactless manner, the coordinate calculation unit outputs the calculated coordinate data on a condition that a number of intersection points at which the touch sensor has detected touching among intersection points of the driving electrodes and the detection electrodes is greater than or equal to a predetermined value.
